(19) United States
(12) Patent Application Publication
(10) Pub. No.: US 2007/0137744 A1
(43) Pub. Date: Jun. 21, 2007

(54) Radial aircraft tire and method of manufacture

(76) Inventors: Kiyoshi Ueyoko, Akron, OH (US); Clarence Byrd Alsobrook III, Akron, OH (US)

Correspondence Address: DAVID L. KING, SR., 5131 N.E. COUNTY ROAD 340, HIGH SPRINGS, FL, 32643, US

(21) Appl. No.: 11/313,016

(22) Filed: Dec. 20, 2005

(51) Int. Cl. B60C 11/00

(52) U.S. Cl. 152/209.1; 152/901

(57) ABSTRACT

A radial aircraft tire has a casing with a belt reinforcing structure overlying a carcass reinforced with radially extending cord reinforced plies and a tread. The tread has four main grooves extending circumferentially continuously around the tire defining five ribs. The main grooves include two inner main grooves disposed on each side of a central rib Y and two outer main grooves defining a pair of intermediate ribs between inner and outer main grooves and a pair of shoulder ribs, X, Z; in each shoulder region of said tire axially outward of an outer main groove. The invention teaches superior tread wear is achieved when the following relationships are fulfilled when the tread surface of the normally rated inflated tire under rated load contacts with a flat surface:

$$\begin{matrix}1. & \frac{( XA + XD ) + ( ZA + ZD )}{( XB + XC ) + ( ZB + ZC )} = 0.5 to 1.05 \\ 2. & \frac{( XA + XB + XC + XD ) + ( ZA + ZB + ZC + ZD )}{TotalNetArea} = 0.34 to 0.75\end{matrix}$$

where the contacting surface portion of the tread is divided into four equal lengths A, B, C, D at the equatorial center-plane and extending axially outwardly therefrom and the shoulder ribs X and Z are each divided into four distinct contact areas within each respective region A, B, C, D the contact areas within each respective region A, B, C, D the contact areas being XA, XB, XC and XD in rib X and ZA, ZB, ZC and ZD in rib Z. In one alternative embodiment the relationship can also be applied to a five groove tire having one main groove on the equatorial plane of the tire.

### FIELD OF THE INVENTION

This invention relates to radial aircraft tires generally and to a method to optimize tread life of such tires more specifically.

### BACKGROUND OF THE INVENTION

Aircraft tires are subject to extreme loads and deflections and are subjected to extreme accelerations and very high speeds particularly on landings, takeoffs and after prolonged taxiing these radial tires can build up high heat all of which can contribute to rapid tread wear.

The tread thickness of radial aircraft tires are ideally kept to minimal thicknesses to insure the forces generated at very high speeds do not create inertial generated forces that might cause the rotating tire to pull the tread or underlying belt structure apart.

Accordingly, the tread needs to be durable, but relatively thin for this application. Each tire manufacturer ideally wants the tread to survive as many takeoffs and landings as possible. The ability to provide tires with superior durability is a tremendous cost advantage to the airlines.

These tires typically are designed to be re-treaded several times to further save cost. However, as the tread wears it is required to be removed from service and be re-treaded. Naturally anything that extends the useful life of the tread is very desirable.

Aircraft treads typically have about four circumferentially continuous straight grooves which are separated by solid or continuous tread ribs. These include a pair of shoulder ribs, a pair of intermediate ribs and a generally wide central. In some cases the central rib may be divided by another circumferentially continuous center groove to make a five groove tread.

The problem associated with such tires is when one tread rib is completely worn the tire must be exchanged with a new or a re-treaded tire as specified by the airframe manufacturer. To increase the number of landings the width of the center rib was increased, but if the center rib becomes too wide, the intermediate and shoulder rib must get narrower. As the shoulder rib narrows the rigidity of this tread portion is reduced and during taxiing transit of the aircraft the abrasion in this region caused rapid tread wear.

One solution was to reduce the number of grooves into two large aqua-channels as is taught in U.S. Pat. No. 6,374,883. This accommodated a larger center rib and naturally a sufficiently large pair of shoulder ribs, however, convincing the users that such a dramatic tread change from the more standard four rib tire was satisfactory if not superior on wet runway conditions has not been easy.

On smaller military aircraft with high camber angles the grooves were all positioned asymmetrically on one tread half to avoid premature wear on the tread half with the solid band area void of grooves was taught in U.S. Pat. No. 5,016,838.

In JP 2003-291611, the tread wear problem is solved by a formula based on tread rib width W wherein W₀ is the width of the center rib, W₁ is the width of the shoulder rib and W₂ is the width of two or more intermediate ribs on a four to six groove aircraft tire where W₀:W₁:W₂ is set to 1:0.35-0.55:0.45-0.55 for four groove tires and W₀:W₁:W₂ is set to a ratio 1:0.65-0.75:0.35-0.45. These width ratios avoid making the rib too narrow while still providing a wide center rib.

The problem associated with the above cited publication JP 2003-291611 is the effect of the tires footprint shape under normal load and inflation are ignored and therefore the formula may be inappropriate for general use as the footprint shape is well known to affect the tread wear of tires generally and in the case of aircraft tires most specifically.

The present invention provides several formulas that when applied to a radial ply aircraft tread will achieve good uniform wear that takes into account the area of the contacting tread ribs in relation to the contact patch or footprint of the tire which is believed to be a superior way to optimize and achieve uniform tread wear.

### SUMMARY OF THE INVENTION

A radial aircraft tire has a casing with a belt reinforcing structure overlying a carcass reinforced with radially extending cord reinforced plies and a tread. The tread has four main grooves extending circumferentially continuously around the tire defining five ribs. The main grooves include two inner main grooves disposed on each side of a central rib Y and two outer main grooves defining a pair of intermediate ribs between inner and outer main grooves and a pair of shoulder ribs, X, Z; in each shoulder region of said tire axially outward of an outer main groove. The invention teaches superior tread wear is achieved when the following relationships are fulfilled when the tread surface of the normally rated inflated tire under rated load contacts with a flat surface:

$$\begin{matrix}1. & \frac{( XA + XD ) + ( ZA + ZD )}{( XB + XC ) + ( ZB + ZC )} = 0.5 to 1.05 \\ 2. & \frac{( XA + XB + XC + XD ) + ( ZA + ZB + ZC + ZD )}{TotalNetArea} = 0.34 to 0.75\end{matrix}$$

where the contacting surface portion of the tread is divided into four equal lengths A, B, C, D at the equatorial center-plane and extending axially outwardly therefrom and the shoulder ribs X and Z are each divided into four distinct contact areas; a leading region A, two middle regions B, C and a trailing region D within each respective region A, B, C, D the contact areas being XA, XB, XC and XD in rib X and ZA, ZB, ZC and ZD in rib Z. In one alternative embodiment the relationship can also be applied to a five groove tire having one main groove on the equatorial plane of the tire.
Definitions

The following definitions are controlling for the disclosed invention.

“Apex” means an elastomeric filler located radially above the bead core and between the plies and the turnup ply.

“Annular” means formed like a ring.

“Aspect ratio” of the tire means the ratio of its section height (SH) to its section width (SW) multiplied by 100% for expression as percentage.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers. The belt structure may also be formed of zigzag layers of strips layered to form a multi-layered structure alone or in combination with belt plies.

“Bias tire” (cross ply) means a tire in which the reinforcing cords in the carcass ply extend diagonally across the tire from bead to bead at about a 25°-65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Chafers” refers to narrow strips of material placed around the outside of the bead to protect cord plies from the rim, distribute flexing above the rim, and to seal the tire.

“Chippers” means a reinforcement structure located in the bead portion of the tire.

“Circumferential” means lines or directions extending along the perimeter of the surface of the annular tire parallel to the Equatorial Plane (EP) and perpendicular to the axial direction.

“Cord” means one of the reinforcement strands of which the plies of the tire are comprised.

“Cord angle” means the acute angle, left or right in a plan view of the tire, formed by a cord with respect to the equatorial plane. The “cord angle” is measured in a cured but uninflated tire.

“Elastomer” means a resilient material capable of recovering size and shape after deformation.

“Equatorial plane (EP)” means the plane perpendicular to the tire's axis of rotation and passing through the center of its tread.

“Flipper” means a reinforced fabric wrapped about the bead core.

“Inner” means toward the inside of the tire and “outer” means toward its exterior.

“Innerliner” means the layer or layers of elastomer or other material that form the inside surface of a tubeless tire and that contain the inflating fluid within the tire.

“Lateral” means an axial direction.

“Ply” means a continuous layer of rubber-coated parallel cords.

“Radial” and “radially” are used to mean directions radially toward or away from the axis of rotation of the tire.

“Radial-ply tire” means a belted or circumferentially-restricted pneumatic tire in which the ply cords which extend from bead to bead are laid at cord angles between 65° and 90° with respect to the equatorial plane of the tire.

“Section height (SH)” means the radial distance from the nominal rim diameter of the tire at its equatorial plane.

“Sidewall” means that portion of a tire between the tread and the bead.

“Tread” means a molded rubber component which, when bonded to a tire casing, includes that portion of the tire that comes into contact with the road when the tire is normally inflated and under normal load.

### BRIEF DESCRIPTION OF THE DRAWINGS

The invention will be described by way of example and with reference to the accompanying drawings in which:

FIG. 1 is a cross sectional view of a tire according to the present invention.

FIG. 2 is an enlarged cross sectional view of an upper shoulder region of the tire of FIG. 1 taken from the equatorial plane and depicting the locations of the inner and outer main circumferential grooves on one half of the tire.

FIG. 3 is a plan view of a tire footprint or contact patch illustrating the representative area of contact each tread rib makes under rated load and rated inflation of the tire shown in FIG. 1.

FIG. 4 is a tire footprint or contact patch of an alternative embodiment tire identical to FIG. 1, however, having an additional center main groove which divides the center rib into two rib portions.

FIG. 5 is a schematic view of several exemplary tire footprints or contact patches for comparing the shoulder rib contact area versus center rib contact area.

FIG. 6 is a schematic view the several exemplary tire footprints or contact patches of FIG. 5 from which the shoulder contact area is compared to the total contact area, the upper quadrant shown shaded.

FIG. 7 is a plan view of a tire footprint of a tire made according to the present invention.

FIG. 8 is a plan view of a prior art footprint showing the tread made outside the acceptable ratios for contact areas.

### DETAILED DESCRIPTION OF THE INVENTION

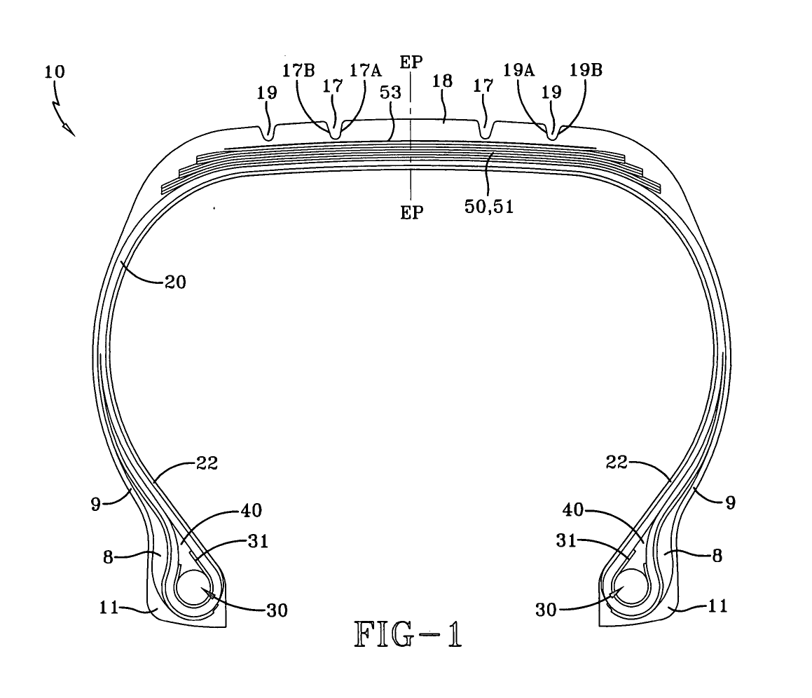

With reference to FIG. 1, a cross-sectional view of a radial ply tire 10 is shown. The tire 10, as illustrated, is a construction for use as an aircraft tire. The tire 10 by way of example is a radial aircraft tire exposed to high internal pressures and tremendous loads.

The tire 10 is a radial ply tire of the tubeless type construction. The tire 10 has an air imperious inner liner 22 which contains fluid or air under pressure. Radially outward of the inner liner 22 are one or more radial plies 20. Each ply 20 extends from an annular tensile member commonly referred to as a bead core 30. As shown the plies 20 wrap about the bead core 30 either turning axially out and up forming a ply turnup or alternately turning axially in and under the bead core 30. Radially above the bead core 30 is a rubber apex 40. The tire bead may be supplemented by a reinforcement chipper ply of textile cords. The chipper can be used to protect the plies 20 against injury during rim mounting. Radially below the bead core area is a chafer 11. Axially outward of the chafer 11 and the plies 20 is an elongated strip 8 of elastomeric material extending from radially inward of the bead adjacent the chafer to a radial location at or slightly above one or more of the ply turnups. This strip 8 is interposed between the sidewall 9 the ply 20. Adjacent the bead core 30 and the plies is a flipper 31 in the exemplary tire as illustrated.

Radially outward of the carcass plies 20 is a plurality of belt reinforcing layers 50, each layer is reinforced with cords 51.

A fabric layer 53 is shown radially outward of the belt layers 50.

Above the fabric layer 53 is a tread 18 as shown, the tread 18 has a plurality of circumferentially continuous main grooves, two grooves 17 being axially inner main grooves and two grooves 19 being axially outer main grooves. Each groove 17, 19 has an axially inner groove wall 17A, 19A and an axially outer groove wall 17B, 19B respectively.

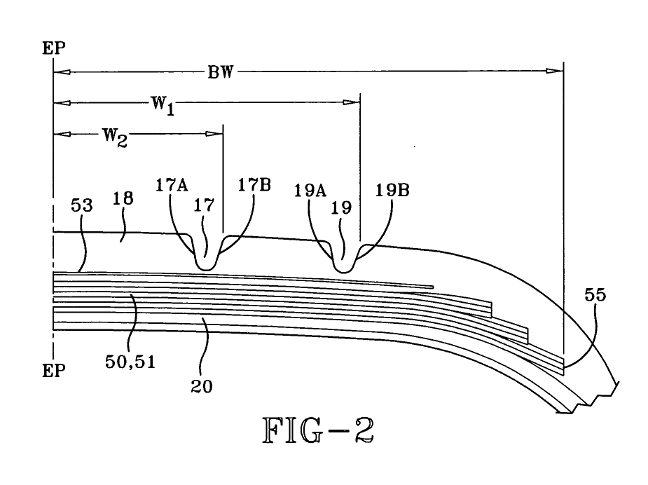

As shown in FIG. 2, the location of the axially inner main groove 17 is spaced at a distance W₂ from the equatorial plane EP of the tire 10 as measured at the axially outer edge location of the axially outer groove wall 17B taken from a cut section of a new tire. The axially outer edge is defined by the extension of the tread arc curvature at the intersection of a line tangent to the groove wall 17B, as shown the location of the axially outer edge as so defined is a point in space because the tread 18 as shown has a small radius of curvature at each groove wall 17A, 17B, 19A, 19B.

The axially outer main groove 19 is located at a distance W₁ as measured from an axially outer edge location taken from the cut section of a new tire as similarly defined by the intersection of the extension of the axially outer wall 19B of groove 19 and the tread arc curvature.

In the preferred practice of the invention the grooves 17 and 19 on the opposite tread half not illustrated are symmetrically positioned the same as the tread half portion shown.

With further reference to FIG. 2, the reinforcing belt structure 50 has an axially outermost edge 55 which is located a distance BW from the equatorial plane EP. The positioning of the grooves 17, 19 is defined by having groove 19 with W₁ equal to 0.30 BW to 0.80 BW, preferably equal to 0.52 BW to 0.70 BW and groove 17 with W₂ equal to 0 to 0.50 BW, preferably 0 to 0.40 BW and wherein W₁>W₂ all measurements being taken from a cut tire section.

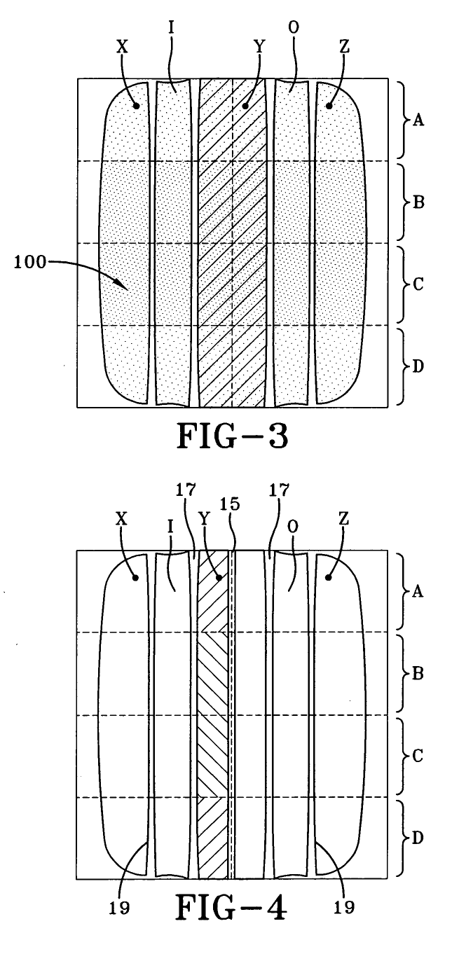

The above locations of main groove locations are subordinate to and somewhat dictated by the contacting surface portion or patch 100 exhibited by the tire 10 when inflated and under rated loaded conditions. The contacting surface portion 100 of the tire 10 is shown in FIG. 3. The area is best understood as the area of the tread that could be seen if one pressed the tread against a glass plate and looked up to see those portions of the tread 18 contacting the glass while under a load and inflation. Often the tread is coated with ink and pressed against a cardboard sheet to leave a permanent mark often referred to as footprinting. Alternatively, electronic pressure pads can be used to measure contact points and even pressure. These and other footprint procedures are well known in the art and any one of such known techniques can be used with the techniques described in the present invention described herein.

With reference to FIG. 3, an exemplary footprint 100 of the tire 10 is shown. The four main grooves 17 and 19 define five circumferentially continuous tread ribs. The central rib Y is located between the pair of axially inner main grooves 17. A pair of intermediate ribs I, O are located as shown each rib being between an axially inner groove 17 and an axially outer groove 19, one such rib is on each half of the tread. Axially outward and adjacent the axially outer main grooves 19 are shoulder ribs X, Z. These ribs X, Y, Z and I, O represent the portions of the tread 18 in contact with the surface when placed under rated load and pressure. The sum of the tread area contacting is referred to as the total net contact area. The curvature of the footprint or contact patch and the grooves with the footprint or contact patch provide the external boundary and internal void area respectively.

By empirical analysis and calculation the present inventors and creators of numerous radial aircraft tire designs have arrived at a precise formula and method to optimize tread wear of such tires.

With reference to FIG. 3, the tread footprint 100 is divided into four equal length zones A, B, C and D by parallel lines axially extending and tangent to the footprint at the leading and trailing edge at the equatorial plane EP, the leading portion being A, the trailing portion D and the middle two portions being B and C. By measuring the area of the shoulder ribs X, Z and the center rib Y areas within each zone a rather precise measurement can be achieved which takes into account the shape of the footprint and the groove locations. For a symmetrical tread to wear uniformly the tire must exhibit a footprint which satisfies the following relationship. The ratio of the contact area of the shoulder ribs X, Z in the shoulder must be:

$$\begin{matrix}1. & \frac{( XA + XD ) + ( ZA + ZD )}{( XB + XC ) + ( ZB + ZC )} = 0.5 to 1.05 \\ 2. & \frac{( XA + XB + XC + XD ) + ( ZA + ZB + ZC + ZD )}{TotalNetArea} = 0.34 to 0.75\end{matrix}$$

where the contacting surface portion of the tread is divided into four equal lengths A, B, C, D at the equatorial center-plane and extending axially outwardly therefrom and the shoulder ribs X and Z are each divided into four distinct contact areas within each respective region A, B, C, D the contact areas; a leading A, two middle B, C and a trailing region D the contact area within each respective region A, B, C, D being XA, XB, XC and XD in rib X and ZA, ZB, ZC and ZD in rib Z.

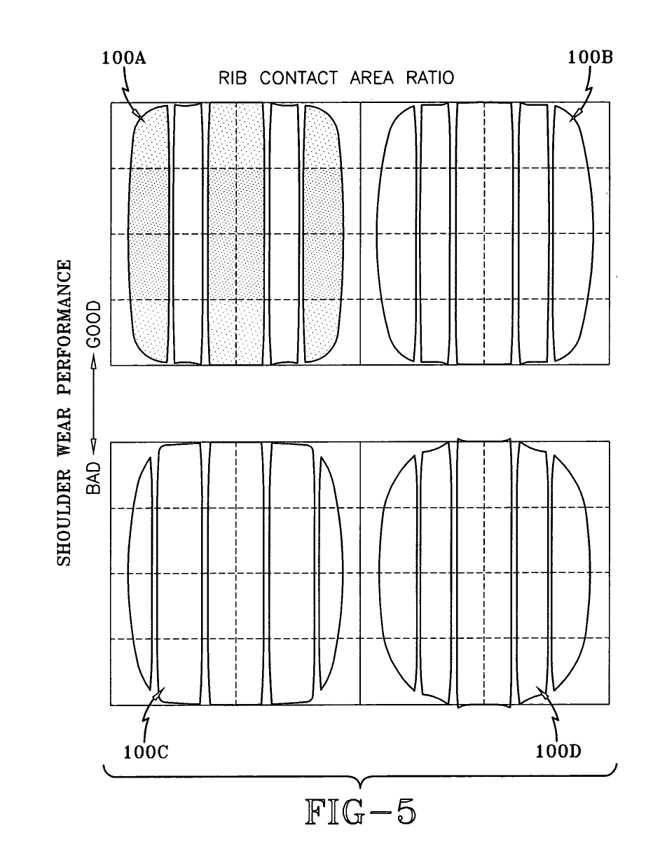

With reference to FIG. 5, four tire footprints or contact patches 100A, 100B, 100C, 100D are shown which will be an exemplary indication of the shoulder wear performance as a function of the ratio of the rib contact area in the shoulder region and also the ratio of the rib contact area of the center rib. In the upper left hand corner the rib tire footprint is illustrated wherein the formula for the ratio of the shoulder region rib X, Z satisfies a contact area relationship showing a ratio of 0.779 wherein the center rib shows an area ratio of 0.992 as defined by the formulas:

$$\frac{( XA + XD ) + ( ZA + ZD )}{( XB + XC ) + ( ZB + ZC )} = 0.5 to 1.05 and$$

$$\frac{YA + YD}{YB + YC} = .95 to 1.05 , respectively .$$

With reference to the tire footprint or contact patch 100B in the upper right hand corner, this tread pattern has a ratio of 0.64 in the shoulder region and the center rib satisfies a 0.992 relationship. Both tires in the upper left and upper right hand portions of FIG. 5 exhibit good, uniform shoulder wear performance. With respect to the FIGS. 100C and 100D in lower left and the lower right hand corner as can be seen the tread patch 100C on the lower left has a narrow shoulder rib that is spaced substantially from the leading and trailing edge where the tread patch 100D on the right lower quadrant is substantially round. These tires exhibit a relationship or ratio wherein the shoulder rib has a 0.438 and the center rib 0.992 on the lower left quadrant and the tire footprint 100D on the lower right quadrant has a 0.457 with a center rib ratio of 1.001, both these tires exhibit relatively poor wear performance in the shoulder regions of ribs X and Z.

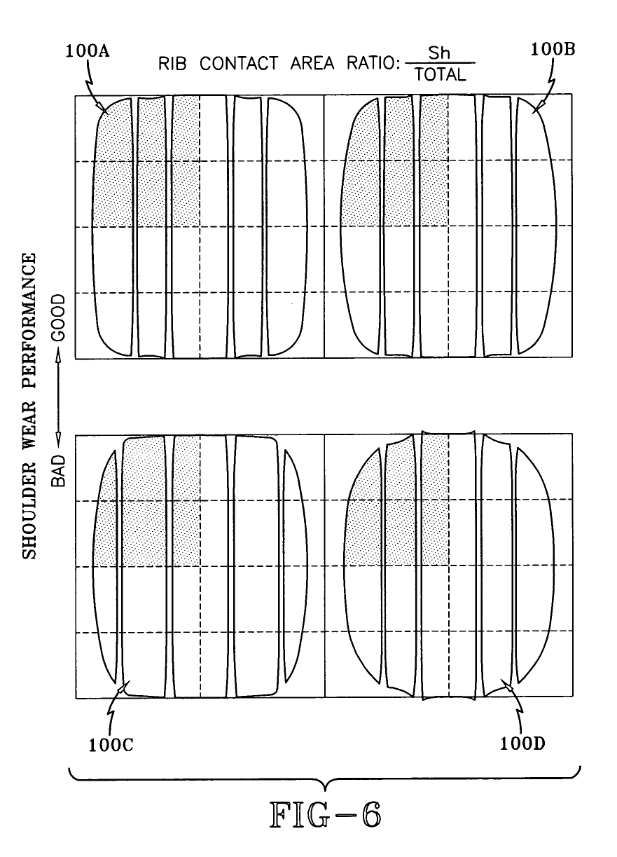

With reference to FIG. 6, the figure exhibits the four footprint patterns 100A-100D wherein the shoulder wear performance can be rated from good to bad. The upper two footprints 100A and 100B exhibit good performance, while the two lower footprints 100C and 100D exhibit poor performance. In these exemplary embodiments similar to those shown in FIG. 5, the rib contact area ratio of the shoulder rib over the total contact area is established. This can be accomplished by looking only at the upper left quadrant, the shaded area shown in the examples. On a symmetrical tire this is possible if the tread pattern was uniformly distributed as shown one only need measure this area and therefore it is highlighted as illustrated, however, for purposes of satisfying the exemplary equations one can take a total calculation and accomplish the same ratios as would be achieved by taking only a section of the tire. Accordingly, if one looks at the relationship of the shoulder rib

$$\frac{( XA + XB + XC + XD ) + ( ZA + ZB + ZC + ZD )}{TotalNetArea} = 0.34 to 0.75$$

If the tire patch 100A in the upper left quadrant has a 0.3825 ratio of the shoulder rib contact area divided by the total contact area, then similarly the tire patch 100B in the upper right has a ratio of 0.3571, both of these ratios are well within the preferred ratio of 0.34-0.75. In the lower quadrant the ratio for the lower left tire patch 100C is 0.1782 and the lower right tire patch 100D is 0.3317, both of these tires exhibit poor shoulder wear performance and fall outside the range of 0.34-0.75 and therefore would be unacceptable.

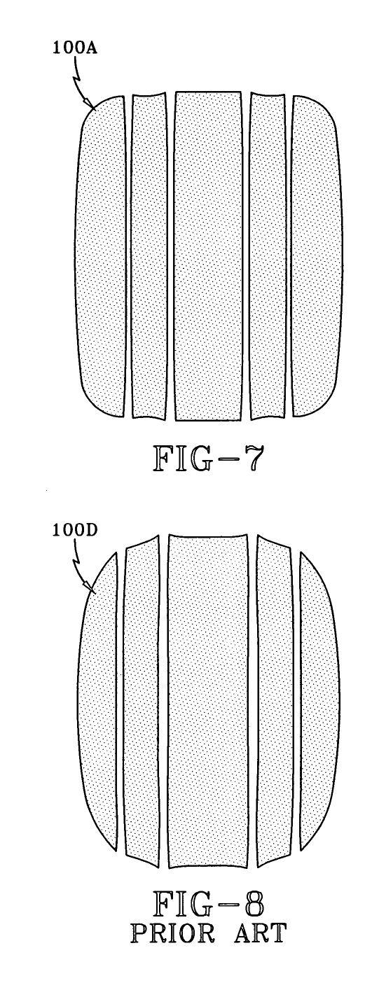

With reference to FIG. 7 and FIG. 8, two tire footprints or patches are shown. The tire footprint or contact patch 100A satisfies the relationships and wherein the tire 10 according to the preferred embodiment of the invention is illustrated in FIG. 7. This tire was built for a Boeing 777/767-400 ER main gear tire and was of a construction 50×20.0 R22 32 PR max speed 235 mph. This tire has a rated load and pressure of 57,100 lbs at 220 psi. The gross contact area achieved by this tire which is the total contact area is 247.79 inches² and the net contact area is 219.89 inches 2. W₁ was located 4.22 inches form the equatorial plane and W₂ was located 2.32 inches and BW was 7.0 inches all from the equatorial plane EP. The ratio of W₁/BW=0.603 and W/BW=0.331. This tire as shown meets all the requirements of the satisfied ratios exhibited both for the shoulder ribs and for the center rib.

Referring to FIG. 8, the prior art tire footprint 100D is shown wherein the total contact area was 231.1 inches² while the net contact area was 218.0 inches². The prior art tire as illustrated fell outside the preferred range of ratios, and therefore exhibited poor shoulder wear performance and non-uniform wear across the tread ribs as compared to the tire 10 of FIG. 7.

It will be appreciated by one of ordinary skill in the art of designing radial aircraft tires that the ability to change a tire's footprint to be within the preferred or desired ratios can be accomplished by changing the tread mold contour, by adding or subtracting belt thickness, or by changing the tread rubber thickness to a profile to more suit to fit the ratios or any combination of such adjustments.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A radial aircraft tire having a casing with a belt reinforcing structure overlying a carcass reinforced with radially extending cord reinforced plies and a tread, the tread comprising four main grooves extending circumferentially continuously around the tire defining five ribs, the main grooves including two inner main grooves disposed on each side of a central rib Y and two outer main grooves defining a pair of intermediate ribs between inner and outer main grooves and a pair of shoulder ribs, X, Z; one rib in each shoulder region of said tire axially outward of an outer main groove wherein the following relationships are fulfilled when the tread surface of the normally inflated tire under rated inflation and rated load contacts with a flat surface:
$$\begin{matrix}1. & \frac{( XA + XD ) + ( ZA + ZD )}{( XB + XC ) + ( ZB + ZC )} = 0.5 to 1.05 \\ 2. & \frac{( XA + XB + XC + XD ) + ( ZA + ZB + ZC + ZD )}{TotalNetArea} = 0.34 to 0.75\end{matrix}$$
where the contacting surface portion of the tread is divided into four equal lengths A, B, C, D at the equatorial center-plane and extending axially outwardly therefrom and the shoulder ribs X and Z are each divided into four distinct contact areas; a leading A, two middle B, C and a trailing region D within each respective region A, B, C, D the contact areas within each respective region A, B, C, D being XA, XB, XC and XD in rib X and ZA, ZB, ZC and ZD in rib Z.

2. The radial aircraft tire of claim 1 wherein the tread surface under load and in contact with a flat surface satisfies the additional relationship:
$$\frac{YA + YD}{YB + YC} = .95 to 1.05$$
where the central rib Y is divided into the four distinct contact areas within the regions A, B, C and D.

3. The radial aircraft tire of claim 1 wherein an axially outer edge of the outer main grooves is located at a distance W1 as measured from a cut tire section of a new tire, W1 satisfying the relationship:
W₁=0.30 BW to 0.8 BW
where BW is the axial distance as measured between the equatorial plane and an axially outer edge of the belt reinforcing structure.

4. The radial aircraft tire of claim 3 wherein W₁=0.52 BW to 0.70 BW.

5. The radial aircraft tire of claim 1 wherein an axially outer edge of the inner main grooves is located at a distance W₂ as measured from a cut tire section of a new tire, W₂ satisfying the relationship: W₂=0 to 0.50 BW; where BW is the axial distance as measured between the equatorial plane and an axially outer edge of the belt reinforcing structure.

6. The radial aircraft tire of claim 1 wherein W₂=0 BW to 0.40 BW.

7. The radial aircraft tire of claim 1 further comprises a center main groove, the center main groove being circumferentially continuous and located in the equatorial plane dividing the rib Y into two ribs Y₁ and Y₂ and wherein
$$\frac{{Y}_{1} A + {Y}_{1} D}{{Y}_{1} B + {Y}_{1} C} = 0.95 to 1.05$$
$$\frac{{Y}_{2} A + {Y}_{2} D}{{Y}_{2} B + {Y}_{2} C} = 0.95 to 1.05$$

8. A method of manufacturing a radial aircraft tire having a casing with a belt reinforcing structure overlying a carcass reinforced with radially extending cord reinforced plies and a tread, the tread comprising four main grooves extending circumferentially continuously around the tire defining five ribs, the main grooves including two inner main grooves disposed on each side of a central rib Y and two outer main grooves defining a pair of intermediate ribs between inner and outer main grooves and a pair of shoulder ribs, X, Z; one rib in each shoulder region of said tire axially outward of an outer main groove, the method comprising:
selecting a mold contour wherein the following relationships are fulfilled when the tread surface of the normally inflated tire under rated inflation and rated load contacts with a flat surface:
$$\begin{matrix}1. & \frac{( XA + XD ) + ( ZA + ZD )}{( XB + XC ) + ( ZB + ZC )} = 0.5 to 1.05 \\ 2. & \frac{( XA + XB + XC + XD ) + ( ZA + ZB + ZC + ZD )}{TotalNetArea} = 0.34 to 0.75\end{matrix}$$
where the contacting surface portion of the tread is divided into four equal lengths A, B, C, D at the equatorial center-plane and extending axially outwardly therefrom and the shoulder ribs X and Z are each divided into four distinct contact areas; a leading A, two middle B, C and a trailing region D within each respective region A, B, C, D the contact areas within each respective region A, B, C, D being XA, XB, XC and XD in rib X and ZA, ZB, ZC and ZD in rib Z.

9. The method of manufacturing the radial aircraft tire of claim 8 wherein the tread surface under load and in contact with a flat surface satisfies the additional relationship:
$$\frac{YA + YD}{YB + YC} = .95 to 1.05$$
where the central rib Y is divided into the four distinct contact areas within the regions A, B, C and D.

10. The method of manufacturing the radial aircraft tire of claim 8 wherein an axially outer edge of the outer main grooves is located at a distance W1 as measured from a cut tire section of a new tire, W1 satisfying the relationship:
W_{1=0.30} BW to 0.8 BW
where BW is the axial distance as measured between the equatorial plane and an axially outer edge of the belt reinforcing structure.

11. The method of manufacturing the radial aircraft tire of claim 10 wherein W_{1=0.52} BW to 0.70 BW.

12. The method of manufacturing the radial aircraft tire of claim 8 wherein an axially outer edge of the inner main grooves is located at a distance W₂ as measured from a cut tire section of a new tire, W₂ satisfying the relationship: W₂=0 to 0.50 BW; where BW is the axial distance as measured between the equatorial plane and an axially outer edge of the belt reinforcing structure.

13. The method of manufacturing the radial aircraft tire of claim 8 wherein W₂=0 BW to 0.40 BW.

14. The method of manufacturing the radial aircraft tire of claim 8 further comprises a center main groove, the center main groove being circumferentially continuous and located in the equatorial plane dividing the rib Y into two ribs Y₁ and Y₂ and wherein
$$\frac{{Y}_{1} A + {Y}_{1} D}{{Y}_{1} B + {Y}_{1} C} = 0.95 to 1.05$$
$$\frac{{Y}_{2} A + {Y}_{2} D}{{Y}_{2} B + {Y}_{2} C} = 0.95 to 1.05$$
